(19) United States
(12) Patent Application Publication
(10) Pub. No.: US 2008/0188235 A1
(43) Pub. Date: Aug. 7, 2008

(54) APPARATUS AND METHOD FOR CONTROLLING AN UPLINK LOAD IN A BROADBAND WIRELESS COMMUNICATION SYSTEM

(75) Inventors: Yong-Seok KIM, Suwon-si (KR); June MOON, Seoul (KR); Soon-Young YOON, Seoul (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-city (KR)

(21) Appl. No.: 12/023,455

(22) Filed: Jan. 31, 2008

(30) Foreign Application Priority Data
Feb. 1, 2007 (KR) 10-2007-10607

(51) Int. Cl. H04Q 7/20

(52) U.S. Cl. 455/453

(57) ABSTRACT

An apparatus and method for controlling an UpLink (UL) load in a broadband wireless communication system are provided. The apparatus includes a determining unit for determining a resource amount to be allocated to each of a plurality of Mobile Stations (MSs) and a Modulation and Coding Scheme (MCS) level to be applied to each MS, an estimator for estimating a load of each MS by using the resource amount and the MCS level and a controller for controlling the resource amount and the MCS level such that the load of each MS does not exceed a first threshold. By determining and controlling the resource amount and MCS level, the apparatus and method reduce interference to a neighboring cell in a broadband wireless communication system.

### PRIORITY

This application claims the benefit under 35 U.S.C. § 119(a) of a Korean patent application filed in the Korean Intellectual Property Office on Feb. 1, 2007 and assigned Serial No. 2007-10607, the entire disclosure of which is hereby incorporated by reference.

### BACKGROUND OF THE INVENTION

1. Field of the Invention

The present invention relates to a broadband wireless communication system. More particularly, the present invention relates to an apparatus and method for controlling an UpLink (UL) load in a broadband wireless communication system.

2. Description of the Related Art

In cellular wireless communication systems, inter-cell interference causes deterioration of system performance. FIG. 1A illustrates interference that occurs between cells in a currently commercialized Code Division Multiple Access (CDMA)-based wireless communication system. In such a CDMA based system, the interference affects a Base Station (BS) when UpLink (UL) communication is performed between the BS and a Mobile Station (MS). Referring to FIG. 1A, interferences signals are shown in a situation where UL communication is made between a BS A 110-1 and a MS A 120-1. That is, a signal from an MS B 120-2 located in the same cell and a signal from an MS C 120-3 located in a neighboring cell act as interference when the UL communication is performed between the BS A 110-1 and the MS A 120-1. In this case, a Rise-over-Thermal (RoT) value is used to measure the UL interference experienced by the BS in the CDMA-based wireless communication system. The RoT value can be expressed by Equation (1) below.

$$\frac{{I}_{oc} + {I}_{or} + {N}_{0}}{{N}_{0}} \qquad ( 1 )$$

In Equation (1), I_{oc} denotes an interference from MSs located in a neighboring cell, Iₒᵣ denotes an interference from MSs located in a cell of the BS and No denotes thermal noise.

In the CDMA-based wireless communication system, the interference Iₒᵣ from the MSs located in the cell of the BS is more significant than other interferences. Therefore, if the measured interference (i.e., the RoT value) exceeds a predetermined threshold, the BS can effectively reduce the interference by collectively decreasing Modulation and Coding Scheme (MCS) levels of the MSs located in the cell by one level.

However, in an Orthogonal Frequency Division Multiplexing (OFDM)-based wireless communication system, which is being actively studied as a next generation communication system, UL interference does not include an interference component Iₒᵣ from the MSs located in the cell of the BS. That is, in the OFDM-based wireless communication system, since MSs located in the same cell use resources of different areas, interference from another MS located in the same cell does not occur in a situation where UL communication is made for one MS. As shown in FIG. 1B, when UL communication is made between a BS A 130-1 and an MS A 140-1 in an OFDM-based system, a signal of an MS C 140-3 located in a neighboring cell acts as interference whereas a signal of an MS B 140-2 does not act as interference. Therefore, UL interference experienced by a BS in the OFDM-based wireless communication system can be expressed by Equation (2) below.

$$\frac{{I}_{oc} + {N}_{0}}{{N}_{0}} \qquad ( 2 )$$

In Equation (2), I_{oc} denotes interference from MSs located in a neighboring cell, and N₀ denotes thermal noise.

As shown in Equation (2) above, in the OFDM-based wireless communication system, the UL interference experienced by the BS is represented by an interference component from a neighboring cell and a thermal noise component. Therefore, it is difficult for the BS alone to cancel the UL interference. That is, in order to reduce the UL interference, the BS must consider interference to a neighboring cell when scheduling is performed on an MS located in the cell of the BS. Accordingly, there is a need for a load control method which can be performed by the BS to reduce the interference to the neighboring cell.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for controlling an UpLink (UL) load in a broadband wireless communication system.

Another aspect of the present invention is to provide an apparatus and method in which a Base Station (BS) reduces interference to a neighboring cell by controlling a resource amount to be allocated to each of a plurality of Mobile Stations (MSs) and a Modulation and Coding Scheme (MCS) level to be applied to each MS in a broadband wireless communication system.

According to an aspect of the present invention, a BS apparatus in a broadband wireless communication system is provided. The BS includes a determining unit for determining a resource amount to be allocated to each MS and an MCS level to be applied to each MS, an estimator for estimating a load of each MS by using the resource amount and the MCS level and a controller for controlling the resource amount and the MCS level such that the load of each MS does not exceed a first threshold.

According to another aspect of the present invention, a method of performing UL scheduling by a BS in a broadband wireless communication system is provided. The method includes determining a resource amount to be allocated to each MS and an MCS level to be applied to each MS, estimating a load of each MS by using the resource amount and the MCS level and controlling the resource amount and the MCS level such that the load of each MS does not exceed a first threshold.

According to yet another aspect of the present invention, a method of performing UL scheduling by a BS in a broadband wireless communication system is provided. The method includes determining a resource amount to be allocated to each MS and an MCS level to be applied to each MS, estimating a load of each MS by using the resource amount and the MCS level, controlling the resource amount and the MCS level such that the load of each MS does not exceed a first threshold and if the load of each MS is less than or equal to the first threshold, controlling the resource amount and MCS level of each MS so that a total sum of loads of all MSs does not exceed a second threshold.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIGS. 1A and 1B are schematic views illustrating interference that affects a neighboring cell and is caused by a Mobile Station (MS) in a conventional wireless communication system;

FIG. 2 is a block diagram illustrating a Base Station (BS) in a broadband wireless communication system according to an exemplary embodiment of the present invention;

FIG. 3 is a block diagram illustrating a scheduler in a broadband wireless communication system according to an exemplary embodiment of the present invention;

FIGS. 4A and 4B are flowcharts illustrating a method of controlling an UpLink (UL) load, performed by a BS, in a broadband wireless communication system according to an exemplary embodiment of the present invention; and

FIGS. 5A and 5B illustrate changes in interference resulted from load control according to an exemplary embodiment of the present invention.

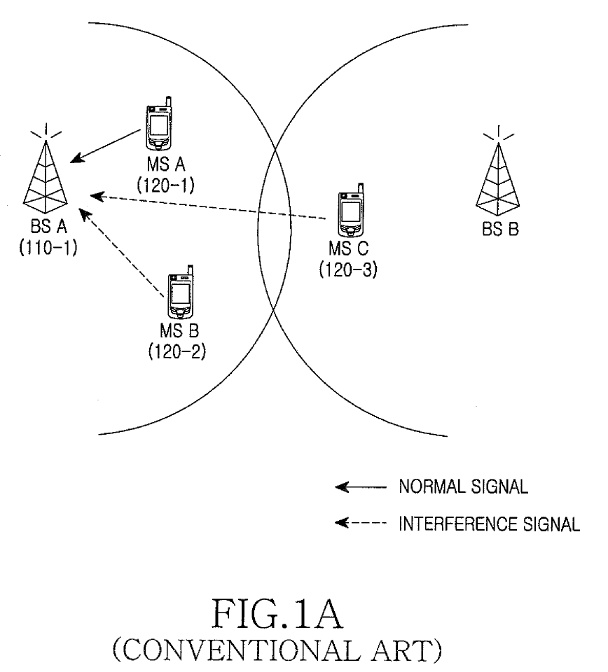

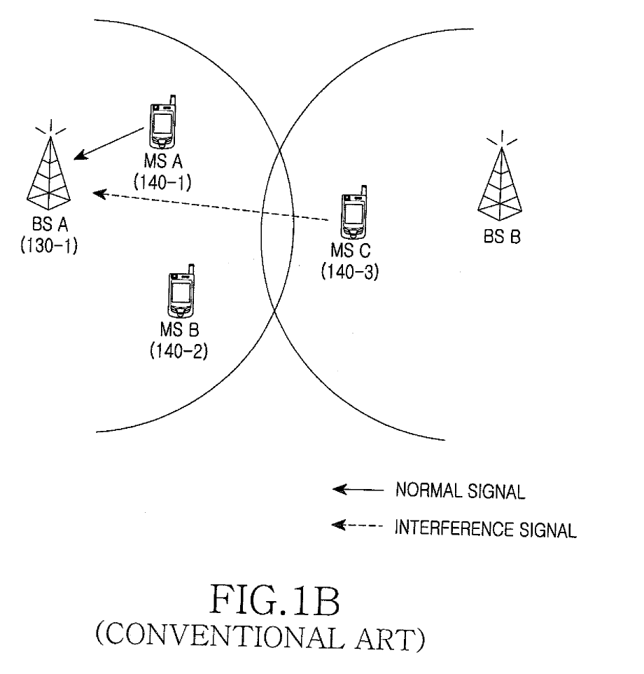

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, an exemplary technique of the present invention will be described for controlling an UpLink (UL) load in a broadband wireless communication system.

An Orthogonal Frequency Division Multiplexing (OFDM)-based wireless communication system will be explained in the present invention as an example. However, the present invention is not limited to an OFDM-based system but is also applicable to other systems based on a frequency division multiplexing scheme.

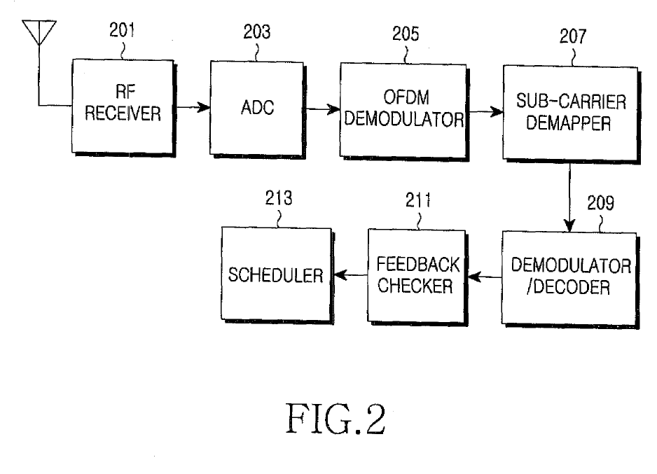

FIG. 2 is a block diagram illustrating a Base Station (BS) in a broadband wireless communication system according to an exemplary embodiment of the present invention.

Referring to FIG. 2, the BS includes a Radio Frequency (RF) receiver 201, an Analog to Digital Converter (ADC) 203, an OFDM demodulator 205, a sub-carrier demapper 207, a demodulator/decoder 209, a feedback checker 211 and a scheduler 213.

The RF receiver 201 converts RF signals received through an antenna into baseband signals. The ADC 203 converts analog signals provided from the RF receiver 201 into digital signals. The OFDM demodulator 205 removes a Cyclic Prefix (CP) from time-domain OFDM symbols provided from the ADC 203 and converts the resultant signals into frequency-domain signals by performing a Fast Fourier Transform (FFT) operation.

The sub-carrier demapper 207 divides the frequency-domain signals provided from the OFDM demodulator 205 into control signals and data signals. The data signals are classified and de-mapped for respective Mobile Stations (MSs). The demodulator/decoder 209 demodulates and decodes complex symbols provided from the sub-carrier demapper 207 according to a suitable method and thus converts the complex symbols into bit-streams.

The feedback checker 211 checks for information that is fed back from the MSs. For example, the feedback checker 211 checks for DownLink (DL) Channel Quality Information (CQI) that is fed back from the MSs.

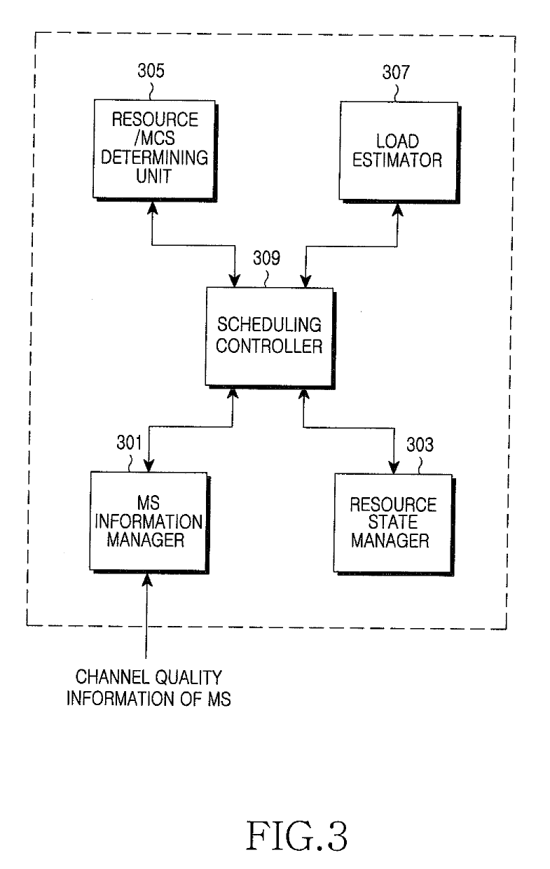

The scheduler 213 allocates resources to the MSs and determines an MCS level to be applied to each MS. According to an exemplary implementation of the present invention, the scheduler 213 controls a UL load in order to reduce interference that affects a neighboring cell due to the UL load. A structure and function of the scheduler 213 for controlling the UL load will be described below in detail with reference to FIG. 3.

FIG. 3 is a block diagram illustrating a scheduler in a broadband wireless communication system according to an exemplary embodiment of the present invention.

Referring to FIG. 3, the scheduler includes an MS information manager 301, a resource state manager 303, a resource/MCS determining unit 305, a load estimator 307 and a scheduling controller 309.

The MS information manager 301 stores and maintains information of a plurality of MSs. At least a part of the information stored and maintained by the MS information manager 301 is required for a scheduling operation. For example, the MS information manager 301 stores and maintains scheduling priority information of each MS, CQI of each MS, etc. The resource state manager 303 stores and maintains resource allocation state information of the scheduling operation. For example, the resource state manager 303 stores and maintains information indicating an amount of resource allocated to a each MS.

By using the CQI of each MS, the resource/MCS determining unit 305 determines a resource amount to be allocated to each MS and an MCS level to be applied to each MS. In an exemplary implementation, the resource amount to be allocated to each MS is determined according to a suitable scheduling method (e.g., a Proportional Fairness (PF) scheduling algorithm and a Maximum Throughput (MT) algorithm). The load estimator 307 estimates a UL load caused by each MS. In this case, the load is estimated by considering the resource amount allocated to each MS, the MCS level, channel quality, etc. For example, the load increases in proportion to channel quality required for the MCS level, an allocated resource amount, noise, and interference, and increases in inverse proportion to channel quality of each MS. This can be expressed by Equation (3) below.

Lⱼ(k)=reqCINR(MCSⱼ(k))+10 log 10(Nschⱼ(k))+NI−CQIⱼ(k) (3)

In Equation (3), Lⱼ(k) denotes a load estimated for an MSj at a k^{th} frame, reqCINR(MCSⱼ(k)) denotes a Carrier to Interference and Noise Ratio (CINR) required for an MSj's MCS level determined at the k^{th} frame, and Nschⱼ(k) denotes a resource amount allocated to the MSj at the k^{th} frame. NI denotes a sum of noise and interference and may be an average value or an instantaneous value. CQIⱼ(k) denotes DL channel quality of the MSⱼ at the k^{th} frame.

The scheduling controller 309 controls the MS information manager 301, the resource state manager 303, the resource/MCS determining unit 305 and the load estimator 307. By controlling these components, the scheduling controller 309 performs scheduling and load control. When the resource allocation and MCS level of each MS are determined, the scheduling controller 309 controls the load estimator 307 to estimate a load Lⱼ(k) of each MS. Thereafter, the scheduling controller 309 controls the resource amount and MCS level of each MS such that the load Lⱼ(k) of each MS does not exceed a first threshold.

If the load Lⱼ(k) of each MS does not exceed the first threshold, the scheduling controller 309 controls a resource amount and MCS level of an MS having the highest load such that a sum of loads of all MSs (i.e., total system load L_{sys}) does not exceed a second threshold. The first threshold for the load Lⱼ(k) of each MS is different from the second threshold for the total system load L_{sys}.

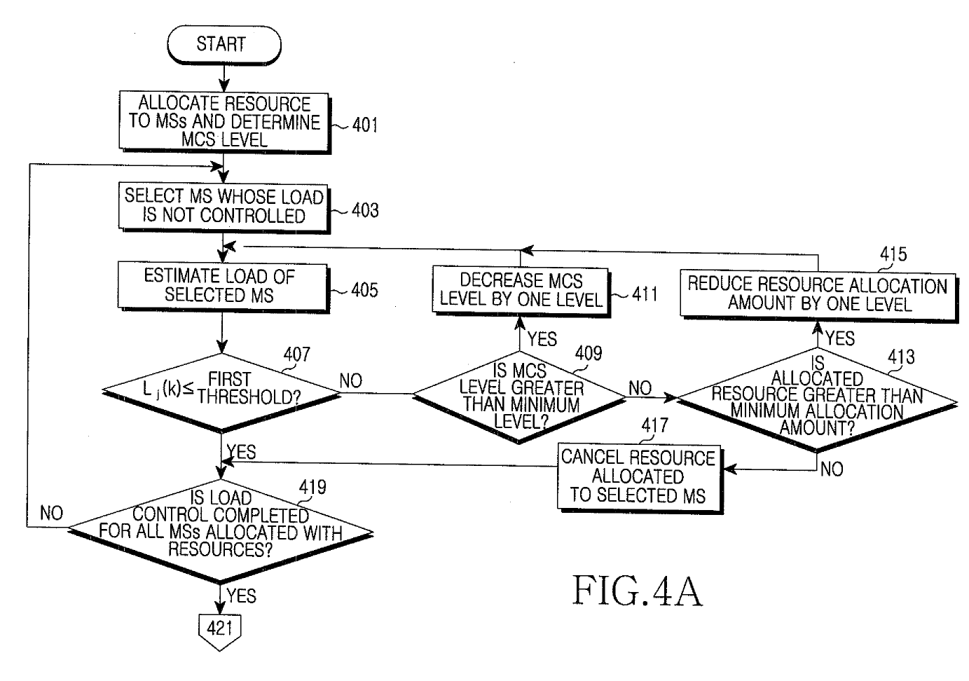

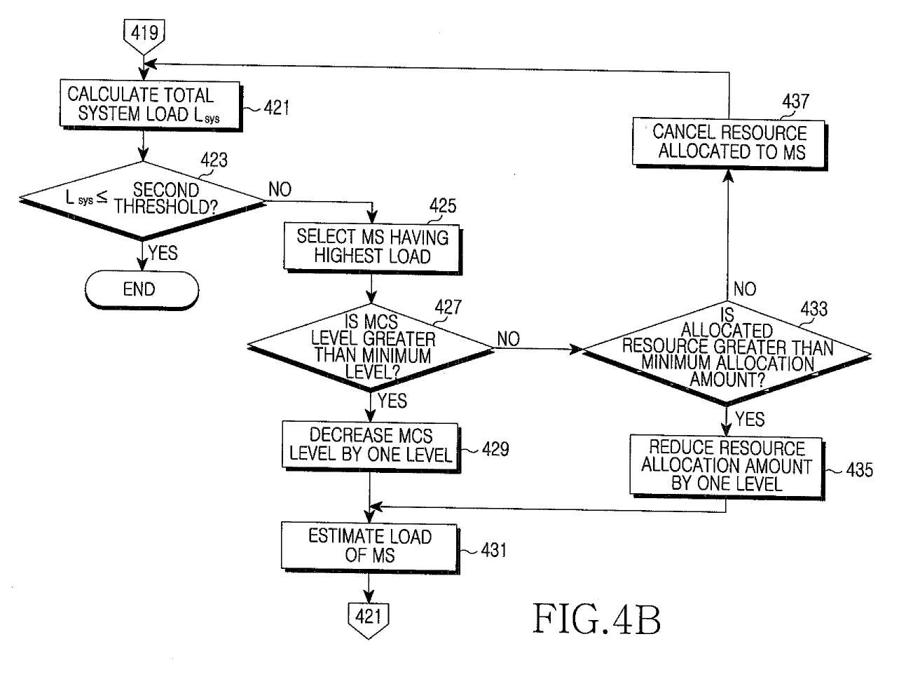

FIG. 4A and FIG. 4B are flowcharts illustrating a method of controlling a UL load, performed by a BS, in a broadband wireless communication system according to an exemplary embodiment of the present invention.

Referring to FIG. 4A and FIG. 4B, in step 401, the BS allocates UL resources to a plurality of MSs and determines an MCS level to be applied to each MS. That is, the BS performs UL scheduling for each MS.

In step 403, the BS selects one MS among the MSs whose loads are not controlled.

In step 405, the BS estimates a load Lⱼ(k) of the selected MS. The load is estimated by using an MCS level, a resource amount, channel quality, etc. For example, the load increases in proportion to channel quality required for the MCS level, an allocated resource amount, noise, and interference, and increases in inverse proportion to channel quality of each MS. This can be expressed by Equation (3) above.

In step 407, the BS compares the estimated load Lⱼ(k) with a first threshold.

If the estimated load Lⱼ(k) is greater than the first threshold, the BS determines whether the MCS level of the selected MS is greater than a minimum level in step 409. That is, the BS determines whether the MCS level of the selected MS can be decreased.

If the MCS level of the selected MS is greater than a minimum level, that is, if the MCS level can be decreased, the BS decreases the MCS level of the selected MS by one level in step 411. Then, the procedure returns to step 405.

Otherwise, if the MCS level cannot be decreased, proceeding to step 413, the BS determines whether the resource amount allocated to the selected MS is greater than a minimum allocation amount. The minimum allocation amount differs depending on a system configuration. That is, the BS determines whether the resource amount allocated to the selected MS can be reduced.

If the resource amount allocated to the selected MS is greater than a minimum allocation amount, that is, if the resource amount can be reduced, the BS reduces the resource amount allocated to the selected MS by one level in step 415. Then, the procedure returns to step 405.

Otherwise, if the resource amount cannot be reduced, the BS cancels the resource allocated to the selected MS in step 417. That is, the BS de-allocates the resource allocated to the selected MS.

In step 419, the BS determines whether load control is completed for all MSs allocated with resources. If the load control is not completed, the BS completes the load control for all MSs by repeating steps 403 to 417.

If the load control is completed, the BS calculates a total system load L_{sys} in step 421. The total system load L_{sys} is obtained by summing all loads estimated for the respective MSs.

In step 423, the BS compares the total system load L_{sys} with a second threshold. If the total system load L_{sys} is less than or equal to the second threshold, the BS ends the procedure of FIG. 4A and FIG. 4B.

Otherwise, if the total system load L_{sys} is greater than the second threshold, proceeding to step 425, the BS selects an MS having the highest load.

In step 427, the BS determines whether an MCS level of the MS having the highest load is greater than a minimum level. That is, the BS determines whether the MCS level of the MS having the highest load can be decreased.

If the MCS level of the MS having the highest load is greater than a minimum level, that is, if the MCS level can be decreased, the BS decreases the MCS level of the MS having the highest load by one level in step 429.

In step 431, the BS estimates a load of the MS having the highest load, and then the procedure returns to step 421.

If the MCS level cannot be decreased in step 427, proceeding to step 433, the BS determines whether a resource amount allocated to the MS having the highest load is greater than a minimum allocation amount. The minimum allocation amount differs depending on the system configuration. That is, the BS determines whether the resource amount allocated to the MS having the highest load can be reduced.

If the resource amount allocated to the MS having the highest load is greater than a minimum allocation amount, that is, if the resource amount can be reduced, the BS reduces the resource amount allocated to the MS having the highest load by one level in step 435. Then, the procedure returns to step 431.

Otherwise, if the resource amount cannot be reduced, the BS cancels the resource allocated to the MS having the highest load in step 437. That is, the BS de-allocates the resource allocated to the MS having the highest load. Thereafter, returning to step 421, the BS repeats steps 421 to 437 until the total system load L_{sys} is less than or equal to the second threshold. The MS having the highest load may vary in each repetition of the above steps.

It has been described with reference to FIG. 4 that the BS performs load control after resources are completely allocated to the MSs in step 401. However, the BS may perform the load control and scheduling by performing steps 403 to 417 whenever a resource is allocated to one MS.

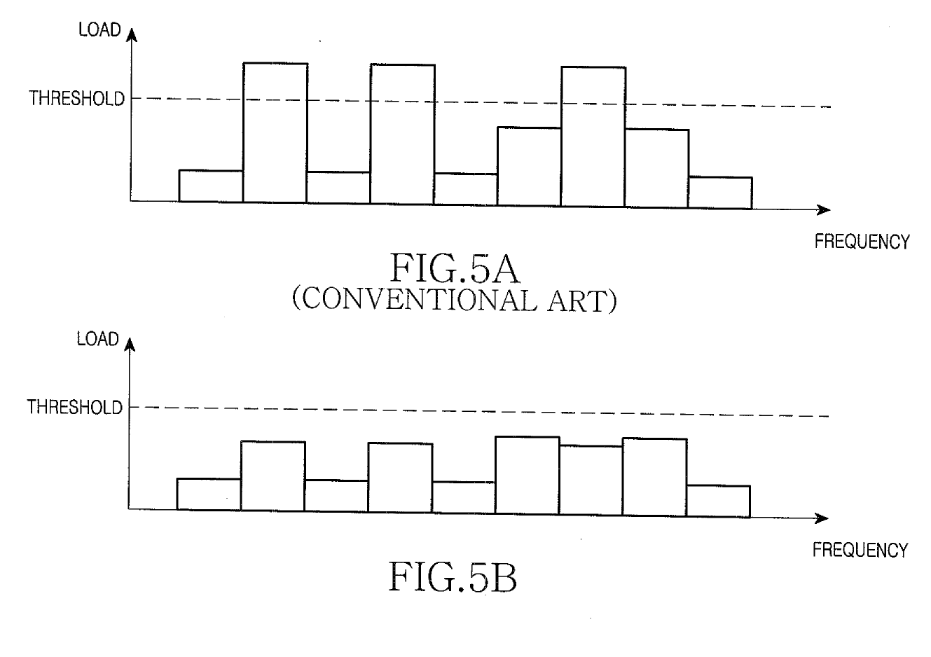

FIGS. 5A and 5B illustrate a change in interference that results from load control according to an exemplary embodiment of the present invention.

FIG. 5A illustrates a conventional load magnitude with respect to a frequency band before load control of the present invention is carried out. FIG. 5B illustrates a load magnitude with respect to a frequency band after load control according to an exemplary embodiment of the present invention is carried out. As seen in the comparison of FIG. 5A and FIG. 5B, as described above, by reducing a load of an MS which is expected to have a high load, a system can avoid occurrence of a high load in a specific frequency band. Therefore, the system can reduce deterioration in reception throughput, which may occur due to unpredictable interference from a neighboring cell.

According to exemplary embodiments of the present invention, interference that affects a neighboring cell can be reduced by controlling a UL load in a broadband wireless communication system.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A Base Station (BS) apparatus in a wireless communication system, comprising:
a determining unit for determining a resource amount to be allocated to each of a plurality of Mobile Stations (MSs) and for determining a Modulation and Coding Scheme (MCS) level to be applied to each MS;
an estimator for estimating a load of each MS by using the resource amount and the MCS level; and
a controller for controlling the resource amount and the MCS level such that the load of each MS does not exceed a first threshold.

2. The apparatus of claim 1, wherein the load estimated by the estimator increases in proportion to at least one of a channel quality required for the MCS level, an allocated resource amount, noise, and interference, and increases in inverse proportion to a channel quality of each MS.

3. The apparatus of claim 2, wherein the estimator estimates the load of each MS by using Equation:
reqCINR(MCS(k))+10 log 10(Nsch(k))+NI−CQI(k),
wherein reqCINR(MCSⱼ(k)) denotes a Carrier to Interference and Noise Ratio (CINR) required for an MCS level determined at a k^{th} frame, Nschⱼ(k) denotes a resource amount allocated at the k^{th} frame, NI denotes a sum of noise and interference, and CQIⱼ(k) denotes DownLink (DL) channel quality at the k^{th} frame.

4. The apparatus of claim 1, wherein the controller decreases an MCS level of an MS by one level when the MS has a load greater than first threshold.

5. The apparatus of claim 4, wherein, if the MCS level cannot be decreased, the controller reduces the resource amount allocated to the MS by one level.

6. The apparatus of claim 5, wherein, if the allocated resource amount cannot be reduced, the controller de-allocates the resource allocated to the MS.

7. The apparatus of claim 1, wherein, if the load of each MS is less than or equal to the first threshold, the controller controls the load so that a total sum of loads of all MSs does not exceed a second threshold.

8. The apparatus of claim 7, wherein, if the total sum of loads exceeds the second threshold, the controller decreases an MCS level of an MS having the highest load by one level.

9. The apparatus of claim 8, wherein, if the MCS level cannot be decreased, the controller reduces a resource amount allocated to the MS having the highest load by one level.

10. The apparatus of claim 9, wherein, if the allocated resource amount cannot be reduced by one level, the controller de-allocates the resource allocated to the MS having the highest load.

11. A method of performing UpLink (UL) scheduling by a Base Station (BS) in a wireless communication system, the method comprising:
determining a resource amount to be allocated to each of a plurality of Mobile Stations (MSs) and a Modulation and Coding Scheme (MCS) level to be applied to each MS;
estimating a load of each MS by using the resource amount and the MCS level; and
controlling the resource amount and the MCS level such that the load of each MS does not exceed a first threshold.

12. The method of claim 11, wherein the load increases in proportion to at least one of a channel quality required for the MCS level, an allocated resource amount, noise, and interference, and increases in inverse proportion to a channel quality of each MS.

13. The method of claim 12, wherein the estimating of the load comprises using Equation:
reqCINR(MCS(k))+10 log 10(Nsch(k))+NI−CQI(k),
wherein reqCINR(MCSⱼ(k)) denotes a Carrier to Interference and Noise Ratio (CINR) required for an MCS level determined at a k^{th} frame, Nschⱼ(k) denotes a resource amount allocated at the k^{th} frame, NI denotes a sum of noise and interference, and CQIⱼ(k) denotes DownLink (DL) channel quality at the k^{th} frame.

14. The method of claim 11, wherein the controlling of the resource amount and the MCS level comprises decreasing an MCS level of an MS by one level when the MS has a load greater than first threshold.

15. The method of claim 14, wherein the controlling of the resource amount and the MCS level comprises, if the MCS level cannot be decreased, reducing a resource amount allocated to the MS by one level.

16. The method of claim 15, further comprising de-allocating the resource allocated to the MS if the allocated resource amount cannot be reduced.

17. The method of claim 11, further comprising controlling the resource amount and MCS level of each MS so that a total sum of loads of all MSs does not exceed a second threshold if the load of each MS is less than or equal to the first threshold.

18. The method of claim 17, wherein the controlling of the resource amount and MCS level of each MS comprises decreasing an MCS level of an MS having the highest load among the MSs by one level if the total sum of loads exceeds the second threshold.

19. The method of claim 18, wherein the controlling of the resource amount and MCS level of each MS comprises reducing a resource amount allocated to the MS having the highest load by one level if the MCS level cannot be decreased.

20. The method of claim 19, further comprising de-allocating the resource allocated to the MS having the highest load if the allocated resource amount cannot be reduced by one level.

21. A method of performing UpLink (UL) scheduling by a Base Station (BS) in a wireless communication system, the method comprising:
determining a resource amount to be allocated to each of a plurality of Mobile Stations (MSs) and a Modulation and Coding Scheme (MCS) level to be applied to each MS;
estimating a load of each MS by using the resource amount and the MCS level;
controlling the resource amount and the MCS level such that the load of each MS does not exceed a first threshold; and
if the load of each MS is less than or equal to the first threshold, controlling the resource amount and MCS level of each MS so that a total sum of loads of all MSs does not exceed a second threshold.

22. The method of claim 21, wherein the estimating of the load comprises using Equation:
reqCINR(MCS(k))+10 log 10(Nsch(k))+NI−CQI(k),
wherein reqCINR(MCSⱼ(k)) denotes a Carrier to Interference and Noise Ratio (CINR) required for an MCS level determined at a k^{th} frame, Nschⱼ(k) denotes a resource amount allocated at the k^{th} frame, NI denotes a sum of noise and interference, and CQIⱼ(k) denotes DownLink (DL) channel quality at the k^{th} frame.

23. The method of claim 21, wherein the controlling of the resource amount and the MCS level such that the load of each MS does not exceed a first threshold comprises decreasing at least one of an MCS level and a resource amount of an MS, which has a load greater than first threshold, by one level.

24. The method of claim 21, wherein the controlling of the resource amount and MCS level of each MS so that a total sum of loads of all MSs does not exceed the second threshold comprises decreasing at least one of an MCS level and a resource amount of an MS having the highest load among the MSs by one level.
